(19) United States
(12) Patent Application Publication
(10) Pub. No.: US 2013/0077015 A1
(43) Pub. Date: Mar. 28, 2013

(54) FRAME STRUCTURE AND LIQUID CRYSTAL MODULE COMPRISING THE SAME

(71) Applicants: Lifeng Wang, Shenzhen (CN); Yanxue Zhang, Shenzhen (CN); Shuozhen Liang, Shenzhen (CN)

(72) Inventors: Lifeng Wang, Shenzhen (CN); Yanxue Zhang, Shenzhen (CN); Shuozhen Liang, Shenzhen (CN)

(21) Appl. No.: 13/375,235

(22) PCT Filed: Sep. 29, 2011
(86) PCT No.: PCT/CN2011/080332

§ 371 Date: Nov. 30, 2011

(30) Foreign Application Priority Data
Sep. 22, 2011 (CN) 201120358129.1

(51) Int. Cl. G02F 1/1333; F16M 13/00

(52) U.S. Cl. 349/58; 211/183

(57) ABSTRACT

The present disclosure discloses a frame structure, which can make the assembling process simple and time-saving and achieve a thin profile and a light weight. A technical solution adopted in the present disclosure is: a frame structure, comprising a frame, a front cover, and a connector for connecting the frame with the front cover that are all integrally formed, and also comprising fixing elements for securing an end of the front cover that is away from the connector to the frame. The present disclosure further discloses a liquid crystal module comprising the frame structure.

### BACKGROUND

1. Technical Field

The present disclosure relates to a frame structure and a liquid crystal module comprising the same.

2. Description of Related Art

Conventional liquid crystal modules generally consist of a backplate, a reflective sheet, a light guide plate, an optical film, a light emitting unit, a middle frame, a liquid crystal plate and a front cover. The backplate, the middle frame and the front cover are independent units respectively. There are also some conventional liquid crystal modules that have the middle frame integrated into the backplate to eliminate the use of the plastic frame. Such liquid crystal modules require a complex and labor-consuming assembling process and are bulky.

### BRIEF SUMMARY

The present disclosure provides a frame structure and a liquid crystal module comprising the same, which can make the assembling process simple and time-saving and achieve a thin profile and a light weight.

An embodiment of the present disclosure provides a frame structure, which comprises a frame, a front cover, and a connector for connecting the frame with the front cover that are all integrally formed, and also comprises fixing elements for securing an end of the front cover that is away from the connector to the frame.

Preferably, the frame, the connector and the front cover are of an injection molded structure.

Preferably, the frame and the front cover include an angle of 180° or 90° therebetween.

Preferably, the front cover is formed with a first through-hole, the frame is formed with a second through-hole corresponding to the first through-hole, and the fixing elements are screws and bolts.

Preferably, the front cover is formed with a concave embossment, and the first through-hole is formed in the concave embossment with a lower surface of the first through-hole being flush with an upper surface of the second through-hole.

Preferably, the frame is formed with a convex embossment, and the second through-hole is formed in the convex embossment with the lower surface of the first through-hole being flush with the upper surface of the second through-hole.

Preferably, the front cover is formed with a first through-hole, the frame is formed with a blind hole corresponding to the first through-hole, and the fixing elements are screws.

Preferably, the front cover is formed with a concave embossment, and the first through-hole is formed in the concave embossment with a lower surface of the first through-hole being flush with an upper surface of the blind hole.

Preferably, the frame is formed with a convex embossment, and the blind hole is formed in the convex embossment with the lower surface of the first through-hole being flush with the upper surface of the blind hole.

An embodiment of the present disclosure further provides a liquid crystal module comprising a frame structure, wherein the frame structure comprises a frame, a front cover, and a connector for connecting the frame with the front cover that are all integrally formed, and also comprises fixing elements for securing an end of the front cover that is away from the connector to the frame.

Preferably, the frame, the connector and the front cover are of an injection molded structure.

An embodiment of the present disclosure further provides a frame structure, which comprises a frame, a front cover, and a connector for connecting the frame with the front cover that are all integrally formed, wherein the front cover is provided with an engaging rod, and the frame is formed with a second through-hole corresponding to the engaging rod.

Preferably, the engaging rod and the front cover are formed integrally.

Preferably, the engaging rod is an elastic structure.

Preferably, the frame, the connector and the front cover are of an injection molded structure.

Preferably, the frame and the front cover include an angle of 180° or 90° therebetween.

An embodiment of the present disclosure further provides a liquid crystal module comprising a frame structure, wherein the frame structure comprises a frame, a front cover, and a connector for connecting the frame with the front cover that are all integrally formed, the front cover is provided with an engaging rod, and the frame is formed with a second through-hole corresponding to the engaging rod.

Preferably, the engaging rod and the front cover are formed integrally.

Preferably, the engaging rod is an elastic structure.

Preferably, the frame, the connector and the front cover are of an injection molded structure.

By having the frame and the front cover formed integrally, the embodiments of the present disclosure can eliminate the step of assembling the frame structure to save both the assembling time and the labor. Having the frame and the front cover formed integrally also makes the whole frame structure thinner and more lightweight.

### BRIEF DESCRIPTION OF THE DRAWINGS

FIG. 1 is a schematic view of a first embodiment of a frame structure according to the present disclosure before being folded over;

FIG. 2 is a schematic view of the first embodiment of the frame structure according to the present disclosure after being folded over;

FIG. 3 is a partial cross-sectional view of FIG. 1 taken along a direction A-A;

FIG. 4 is a partial cross-sectional view of FIG. 2 taken along a direction B-B;

FIG. 5 is a partial cross-sectional view of a second embodiment of the frame structure according to the present disclosure before being folded over;

FIG. 6 is a partial cross-sectional view of the second embodiment of the frame structure according to the present disclosure after being folded over; and

FIG. 7 is a partial cross-sectional view of an embodiment of a liquid crystal module according to the present disclosure.

Hereinafter, implementations, functional features and advantages of the present disclosure will be further described with reference to embodiments thereof and the attached drawings.

### DETAILED DESCRIPTION

It shall be understood that, the embodiments described herein are only intended to illustrate but not to limit the present disclosure.

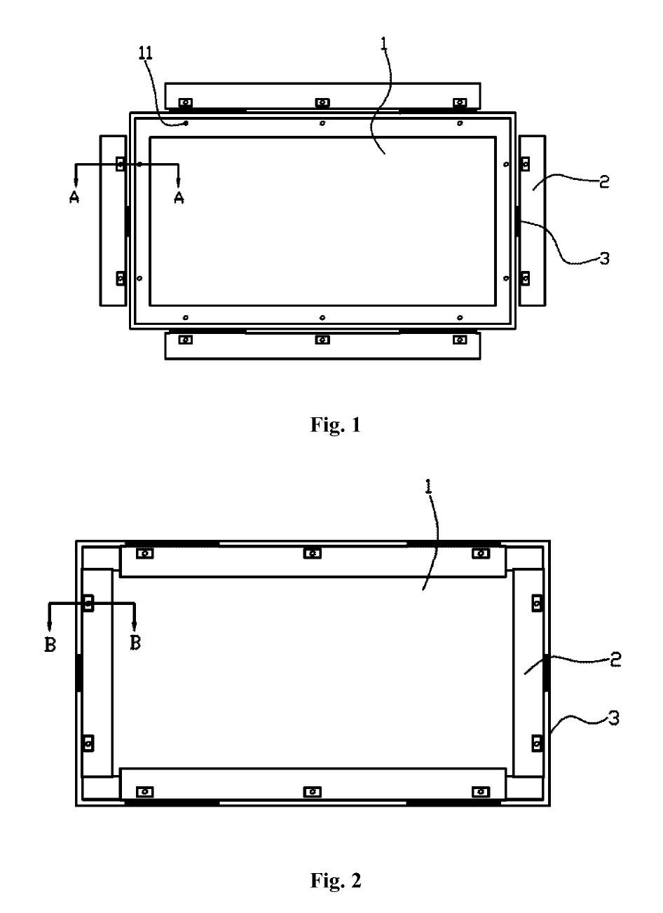

Referring to FIG. 1 and FIG. 2 together, FIG. 1 is a schematic view of a first embodiment of a frame structure according to the present disclosure before being folded over; and FIG. 2 is a schematic view of the first embodiment of the frame structure according to the present disclosure after being folded over. The frame structure comprises a frame 1, a front cover 2, a connector 3 and fixing elements. The frame 1, the front cover 2 and the connector 3 are integrally formed. The frame 1 is connected to the front cover 2 via the connector 3. An end of the front cover 2 that is away from the connector 3 is rotated with respect to the frame 1 and is then fixed by the fixing elements to the frame 1. In this case, the front cover 2 is completely rotated onto the upper surface of the frame 1.

In an embodiment, the frame 1, the front cover 2 and the connector 3 are made of a plastic material through injection molding. After being injection molded, the frame 1 and the front cover 2 include an angle of 180° therebetween. Of course, the frame 1 and the front cover 2 may also include an angle of 90° therebetween for convenience of demoulding.

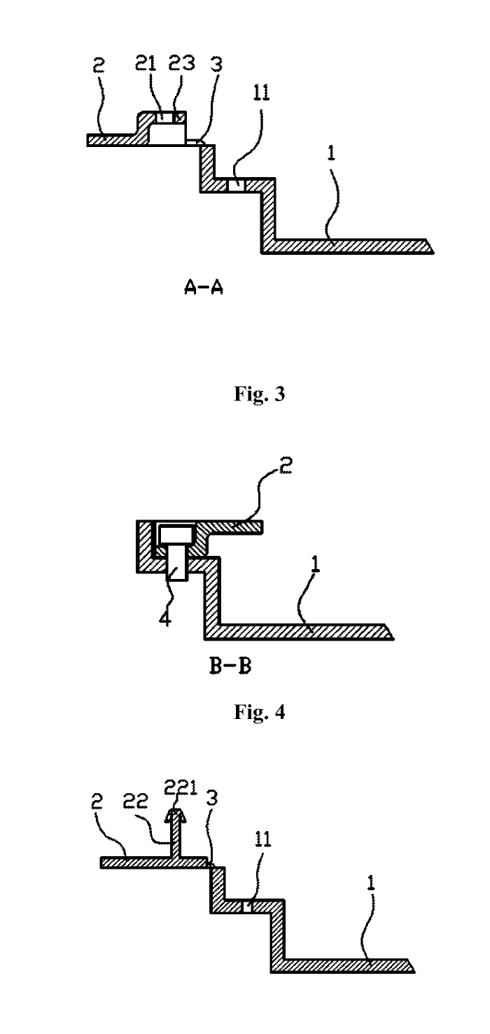

The fixing elements may be of various structures; and in an embodiment, the fixing elements may be screw locking structures. Referring to FIG. 3 and FIG. 4, FIG. 3 is a partial cross-sectional view of FIG. 1 taken along a direction A-A; and FIG. 4 is a partial cross-sectional view of FIG. 2 taken along a direction B-B. The front cover 2 is formed with a first through-hole 21, and the frame 1 is formed with a second through-hole 11 corresponding to the first through-hole 21. When the end of the front cover 2 that is away from the connector 3 is rotated with respect to the frame 1, the first through-hole 21 and the second through-hole 11 are aligned with each other and the end of the front cover 2 that is away from the connector 3 is fixed to the frame 1 by a screw 4 in conjunction with a bolt.

In an embodiment, in order to fix the front cover 2 to the frame 1 with enhanced strength and stability, the front cover 2 is formed with a concave embossment 23 and the first through-hole 21 is formed in the concave embossment 23. When the end of the front cover 2 that is away from the connector 3 is fixed to the frame 1 by the screw 4 in conjunction with the bolt, a lower surface of the first through-hole 21 is flush with an upper surface of the second through-hole 11.

Of course, simple variations may also be made. For example, the frame 1 is formed with a convex embossment, and the second through-hole 11 is formed in the convex embossment. When the end of the front cover 2 that is away from the connector 3 is fixed to the frame 1 by the screw 4 in conjunction with the bolt, the lower surface of the first through-hole 21 is flush with the upper surface of the second through-hole 11.

In an embodiment, the screw locking structure may be a screw in conjunction with a blind hole. The front cover 2 is formed with a first through-hole 21, and the frame 1 is formed with a blind hole corresponding to the first through-hole 21. When the end of the front cover 2 that is away from the connector 3 is rotated with respect to the frame 1, the first through-hole 21 and the blind hole are aligned with each other and the end of the front cover 2 that is away from the connector 3 is fixed to the frame 1 by the screw.

In an embodiment, in order to fix the front cover 2 to the frame 1 with enhanced strength and stability, the front cover 2 is formed with a concave embossment 23 and the first through-hole 21 is formed in the concave embossment 23. When the end of the front cover 2 that is away from the connector 3 is fixed to the frame 1 by the screw, a lower surface of the first through-hole 21 is flush with an upper surface of the blind hole.

Of course, simple variations may also be made. For example, the frame 1 is formed with a convex embossment, and the blind hole is formed in the convex embossment. When the end of the front cover 2 that is away from the connector 3 is fixed to the frame 1 by the screw, the lower surface of the first through-hole 21 is flush with the upper surface of the blind hole.

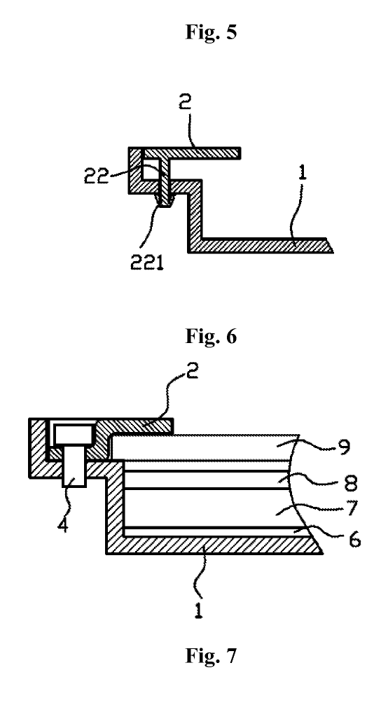

In this embodiment, referring to FIG. 5 and FIG. 6, FIG. 5 is a partial cross-sectional view of a second embodiment of the frame structure according to the present disclosure before being folded over; and FIG. 6 is a partial cross-sectional view of the second embodiment of the frame structure according to the present disclosure after being folded over. The frame 1 is formed with a second through-hole 11, and the front cover 2 is integrally formed with an engaging rod 22. An end of the engaging rod 22 that is away from the front cover 2 is provided with an engaging petal 221, which is in the form of a truncated cone. When the end of the front cover 2 that is away from the connector 3 is rotated with respect to the frame 1, the engaging petal 221 is extruded by the second through-hole 11 to such a extent that an outer diameter of the engaging petal 221 becomes smaller than an inner diameter of the second through-hole 11, so the engaging rod 22 can pass through the second through-hole 11 to fix the end of the front cover 2 that is away from the connector 3 to the frame 1. If there is a need to disengage the end of the front cover 2 that is away from the connector 3 from the frame 1, then by simply extruding the engaging petal 221 to make the outer diameter of the engaging petal 221 smaller than the inner diameter of the through-hole 11, the engaging petal 221 can be disengaged from the through-hole 11 (i.e., the end of the front cover 2 that is away from the connector 3 can be disengaged from the frame 1).

In order to solve the problem of interference that possibly occurs between the engaging rod 22 and the upper surface of the second through-hole 11 of the frame 1 when the front cover 2 is rotated, the engaging rod 22 is preferably an elastic structure.

An embodiment of the present disclosure further provides a liquid crystal module. Referring to FIG. 7, there is shown a partial cross-sectional view of an embodiment of a liquid crystal module according to the present disclosure. For convenience of description, only parts related to this embodiment of the present disclosure are illustrated. The liquid crystal module comprises a frame structure, a reflective sheet 6, a light guide plate 7, an optical film 8, a liquid crystal plate 9 and a light emitting diode (LED) strip. The frame structure comprises a frame 1 and a front cover 2 that are integrally formed. The frame structure is the aforesaid frame structure, and thus will not be further described herein. The optical film 8, the light guide plate 7 and the reflective sheet 6 are stacked on the bottom surface of the frame 1 sequentially from top to bottom. The liquid crystal plate 9 is supported by the upper surface of the second through-hole 11 in the frame 1. The liquid crystal plate 9 is located on the optical film 8, and is pressed by the front cover 2. The LED strip is disposed at a side of the light guide plate 7, which is not shown in Fig. 7.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

1. A frame structure, comprising a frame, a front cover, and a connector for connecting the frame with the front cover that are all integrally formed, and also comprising fixing elements for securing an end of the front cover that is away from the connector to the frame.

2. The frame structure of claim 1, wherein the frame, the connector and the front cover are of an injection molded structure.

3. The frame structure of claim 2, wherein the frame and the front cover include an angle of 180° or 90° therebetween.

4. The frame structure of claim 3, wherein the front cover is formed with a first through-hole, the frame is formed with a second through-hole corresponding to the first through-hole, and the fixing elements are screws and bolts.

5. The frame structure of claim 4, wherein the front cover is formed with a concave embossment, and the first through-hole is formed in the concave embossment with a lower surface of the first through-hole being flush with an upper surface of the second through-hole.

6. The frame structure of claim 4, wherein the frame is formed with a convex embossment, and the second through-hole is formed in the convex embossment with the lower surface of the first through-hole being flush with the upper surface of the second through-hole.

7. The frame structure of claim 3, wherein the front cover is formed with a first through-hole, the frame is formed with a blind hole corresponding to the first through-hole, and the fixing elements are screws.

8. The frame structure of claim 7, wherein the front cover is formed with a concave embossment, and the first through-hole is formed in the concave embossment with a lower surface of the first through-hole being flush with an upper surface of the blind hole.

9. The frame structure of claim 7, wherein the frame is formed with a convex embossment, and the blind hole is formed in the convex embossment with the lower surface of the first through-hole being flush with the upper surface of the blind hole.

10. A liquid crystal module comprising a frame structure, wherein the frame structure comprises a frame, a front cover, and a connector for connecting the frame with the front cover that are all integrally formed, and also comprises fixing elements for securing an end of the front cover that is away from the connector to the frame.

11. The liquid crystal module of claim 10, wherein the frame, the connector and the front cover are of an injection molded structure.

12. A frame structure, comprising a frame, a front cover, and a connector for connecting the frame with the front cover that are all integrally formed, wherein the front cover is provided with an engaging rod, and the frame is formed with a second through-hole corresponding to the engaging rod.

13. The frame structure of claim 12, wherein the engaging rod and the front cover are formed integrally.

14. The frame structure of claim 13, wherein the engaging rod is an elastic structure.

15. The frame structure of claim 14, wherein the frame, the connector and the front cover are of an injection molded structure.

16. The frame structure of claim 15, wherein the frame and the front cover include an angle of 180° or 90° therebetween.

17. A liquid crystal module comprising a frame structure, wherein the frame structure comprises a frame, a front cover, and a connector for connecting the frame with the front cover that are all integrally formed, the front cover is provided with an engaging rod, and the frame is formed with a second through-hole corresponding to the engaging rod.

18. The liquid crystal module of claim 17, wherein the engaging rod and the front cover are formed integrally.

19. The liquid crystal module of claim 18, wherein the engaging rod is an elastic structure.

20. The liquid crystal module of claim 19, wherein the frame, the connector and the front cover are of an injection molded structure.
